(19) United States
(12) Patent Application Publication
(10) Pub. No.: US 2025/0104178 A1
(43) Pub. Date: Mar. 27, 2025

(54) SYSTEMS AND METHODS OF OPTIMIZING GRAPHICS DISPLAY PROCESSING FOR USER INTERFACE SOFTWARE

(71) Applicant: VIZIO, INC., Irvine, CA (US)

(72) Inventors: Joseph Marshall, Garland, TX (US); Matthew Marshall, Richardson, TX (US)

(73) Assignee: VIZIO, INC., Irvine, CA (US)

(21) Appl. No.: 18/888,341

(22) Filed: Sep. 18, 2024

Related U.S. Application Data
(60) Provisional application No. 63/539,633, filed on Sep. 21, 2023.

(51) Int. Cl. G06T 1/20; G06T 1/60

(52) U.S. Cl. CPC G06T 1/20; G06T 1/60

(57) ABSTRACT

A consolidated compositing block architecture is configured to generate a single graphics plane from graphical components of disparate graphical processes. The consolidated compositing block architecture intercepts a function call from a set of framebuffers to a hardware abstraction layer. The function call from each framebuffer may be associated with a graphical component to be rendered. The consolidated compositing block architecture composites the graphical component of one or more framebuffers of the set of framebuffers into a single graphics plane. The consolidated compositing block architecture then transmits the single graphics plane to the hardware abstraction layer for rendering within a display of display device.

### CROSS-REFERENCE TO RELATED APPLICATIONS

The present patent application claims the benefit of priority to U.S. Provisional Patent Application No. 63/539,633 filed Sep. 21, 2023, which is incorporated herein by reference in its entirety for all purposes.

### TECHNICAL FIELD

This disclosure relates generally to graphics display processing, and more particularly to a graphics management subsystem configured to optimize graphics display processing by coordinating rendering and display functions into a single managed context.

### BACKGROUND

Rendering a user interface on display devices (e.g., televisions, monitors, mobile devices such as smartphones or tablets, etc.) supporting a mix of native and third-party applications can be challenging. The combination of text, graphics, and video elements present a challenge to supporting graphics systems which potentially overload memory as well as computing resources. Current approaches to rendering the complex mix of text and graphics with video elements can often cause noticeable lags in the expected presentation of the overall user experience.

For example, current user applications expect that a graphical output of the user application has priority over other applications and native process through the processes that allow the user application to execute and display typically rich graphics to the user interacting with the app. At the same time, user interfaces native to the display device or set top box may also expect priority over the applications, including the user applications, executing by display device or set top box to assure timely display of all information and associated graphics. Current approaches create visual latency when graphical output of user applications and the graphical output of processes native to the display device or set top box compete attempt to present a graphical output at the same time causing the user applications, the processes native to the display device or set top box, or both to wait while the display device or set top box processes the respective graphical outputs according to a predefined order.

The systems and methods of this disclosure present a significant improvement in the efficiency and hence timeliness of managing a complex interactive user interface experience.

### SUMMARY

Methods and systems are described herein for optimizing graphical display processing in display devices. The method may include intercepting a function call from a set of framebuffers to a hardware abstraction layer (HAL), wherein the function call from each framebuffer of the set of framebuffers is associated with a graphical component to be displayed within a graphical user interface; compositing the graphical component of one or more framebuffers of the set of framebuffers into a single graphics plane, wherein the function call of the one or more framebuffers is intercepted over a common time interval; and transmitting the single graphics plane to the hardware abstraction layer for rendering within a display of display device

The systems described herein for optimizing graphical display processing in display devices. The systems may include one or more processors and a non-transitory computer-readable medium storing instructions that, when executed by the one or more processors, cause the one or more processors to perform any of the methods as previously described.

The non-transitory computer-readable media described herein may store instructions which, when executed by one or more processors, cause the one or more processors to perform any of the methods as previously described.

These illustrative examples are mentioned not to limit or define the disclosure, but to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 illustrates a block diagram of an example user interface graphics processing block architecture according to aspects of the present disclosure

FIG. 2 illustrates a block diagram of an example graphics management subsystem including a consolidated compositing block architecture according to aspects of the present disclosure.

FIG. 3 illustrates a block diagram of an example graphics compositing system utilizing a Wayland compositor in place of the DirectFB according to aspects of the present disclosure.

FIG. 4A illustrates an example graph representation of a time allocation trace generated using current architecture according to aspects of the present disclosure.

FIG. 4B illustrates an example graph representation of a time allocation trace generated using graphics management subsystem according to aspects of the present disclosure.

FIG. 5 illustrates a flowchart of an example process for detecting boundaries relative to linear programming according to aspects of the present disclosure.

FIG. 6 illustrates an example computing device architecture of an example computing device that can implement the various techniques described herein according to aspects of the present disclosure.

### DETAILED DESCRIPTION

Systems and methods disclosed herein for optimizing graphics displaying processing in display devices and/or set top boxes that execute graphics-based processes. In some examples, a graphics management subsystem may be provided to coordinate critical graphics rendering and display functions into a single, managed pipeline. The graphics management subsystem may intercept function calls from processes with graphical outputs enabling the graphics management subsystem to optimize graphics display processing without any additional modifications to the processes of the display device with graphical outputs. The graphics management subsystem may utilize a specialized compositor for the first graphic output protocol (GOP) layer that reduces memory usage and allows the graphics management subsystem to render multiple graphical user interfaces (and/or windows) in a single graphics display process (referred to herein as a context). The graphics management subsystem may allow for a more efficient processing of complex user interfaces of display devices and set-top boxes where third-party applications may be generating graphics for screen display at the same time as display processes native to the display device or set-top box. Additionally, the graphics management subsystem may enable a consistent high-definition display in display devices and set-top boxes using arbitrary performance central processing units (CPU) (e.g., high, medium, or low performance CPUs, etc.).

Currently, the graphics processor of a display device or set-top box may generate a new buffer each time an application and native process of a display device and set-top box attempts to output graphics (e.g., a new graphical user interface, update a graphical user interface, etc.). The graphics processor may then render (also referred to herein as compositing) all of the graphical user interfaces (and/or windows) to be displayed each time a new buffer is generated. Rendering all of the windows each time a new buffer is generated may increase memory usage, reduce framerate when multiple applications are animating, cause a significant memory bandwidth cost, and increase rendering latency.

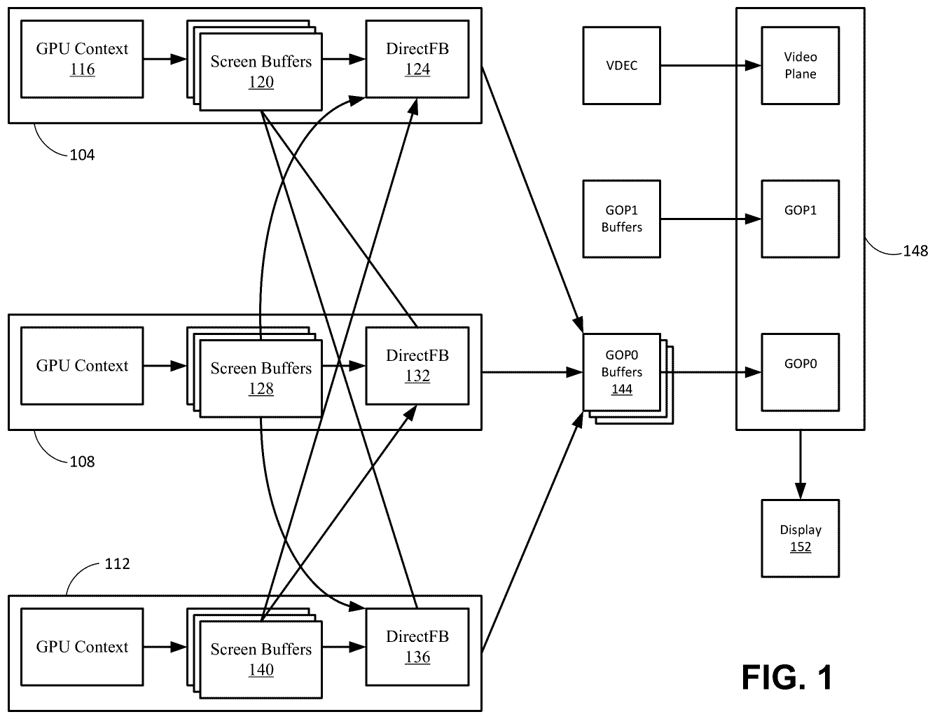

For example, FIG. 1 illustrates a block diagram of an example graphics processing block architecture according to aspects of the present disclosure. A display device may execute multiple processes that each may output to the display device. For example, process 104, process 108, and process 112 as shown are three example process that may present a graphical output at the same time. Each of process 104, process 108, and process 112 may include a GPU context (e.g., such as GPU context 116 of process 104), which may output graphical information to a Screen Buffer (e.g., Screen Buffer 120 of process 104). The Screen Buffer may pass the graphical information into a Direct Framebuffer process (e.g., referred to as DirectFB such as DirectFB 124 of process 104). The DirectFB process may be instantiated from a DirectFB library, which may be an open-sources component of the operating system of the display device (e.g., such as a Linux-based operating system, etc.). The DirectFB library provides graphics rendering services to applications with graphics output including native applications, operating system applications or processes, third-party applications, etc.

DirectFB (e.g., a contraction of Direct Framebuffer) is library that provides a hardware-accelerated graphics environment for embedded systems and other low-level platforms. The DirectFB library enables applications to access and manipulate the graphics hardware directly, without using a traditional windowing system, which may be a fast, efficient way to render graphics on resource-constrained systems.

DirectFB windows may be generated and managed by the DirectFB window manager, which may handle window creation, resizing, and positioning. DirectFB windows can be created in a variety of sizes and shapes, and can be given different attributes such as transparency, borders, and decorations. Overall, DirectFB windows provide a flexible and efficient way to create graphical user interfaces within the DirectFB display system and are an important component of many embedded and low-level systems.

DirectFB windows may support hardware acceleration features such as, but not limited to: blitting (e.g., referring to “block image transfer” or bit blit, which is a highly parallel memory transfer and logic operation unit that supports multiple modes of operation including copying blocks of memory, filling blocks of memory by polygon filling, line drawing, etc.), alpha blending (e.g., merging graphics layers using an alpha (transparency) channel the determines the opaqueness of each pixel of its associated frame buffer layer), drawing primitives (e.g., enabling smoother graphics performance on supported devices), multiple layers (e.g., associating graphical components with layers within a scene to improve visual appearance of rendered media and corresponding processing), windowing systems (e.g., DirectFB may include a built-in windowing system that supports basic window handling, input events, and event handling), input devices (e.g., DirectFB may support various input devices such as keyboards, mice, and touchscreens, allowing for user interaction with graphical applications), image and font support (e.g., DirectFB may support loading and rendering of common image formats like JPEG, PNG, GI, etc. and may include built-in support for specific font families), combinations thereof, or the like.

DirectFB may be used for systems where a desktop environment or windowing system (such as X11 or Wayland) is not required or not usable due to resource constraints. DirectFB can be used to create lightweight graphical applications, kiosk systems, and user interfaces on Linux-based embedded devices with limited processing power and memory. For 3D graphics or more complex 2D graphics requirements, other APIs such as OpenGL, Vulkan, or the like may be used.

The DirectFB library may include one or more requirements for using DirectFB processes to enable processing the multiple processes. For instance, if process 104 is outputting a graphic that is intended to be on top of a graphic of process 108, the respective DirectFB processes may need to identify the other DirectFB processes that may be executing. Screen Buffer 120 may execute a call to DirectFB 128 of process 108 and DirectFB 132 of process 112. Similarly, Screen Buffer 136 of process 108 may execute a call to DirectFB 124 and DirectFB 132 of process 112 and Screen Buffer 140 of process 112 may execute a call to DirectFB 124 and DirectFB 128 of process 112.

Each DirectFB process may execute a call to a graphics processing unit (GPU) render process (which can be accessed via the Hardware Adaptation Layer (HAL) 148). HAL 148 is abstraction layer configured to enable hardware access to executing applications. The call to the GPU render process may cause one or more temporary memory buffers 144 to be instantiated. Since each call to the GPU render process may instantiate one or more temporary memory buffers when the respective DirectFB is ready to send a job to the HAL for rendering and display, a large quantity of temporary memory buffers may be instantiated for even a few graphical processes, which may create a substantial memory and processor load causing a significant slowing of the responsiveness of a user interface or other graphical content.

The display device may include additional processes to process 104, process 108, and process 112. In some examples, the processes may represent different applications of a smart television. For example, process 104 may represent a conjure process, process 108 may represent system-level user interfaces (e.g., such as the menus that control operation of the smart television and enable selection of various media streams, etc.), and process 112 may represent a digital television service (e.g., broadcast media, streaming media, etc.). Since process 108 (e.g., system-level user interfaces) operates in parallel with other processes of the display device, process 108 may compete for processes resources and time when rendering new graphical output or a modified graphical output. In some instances, the competition between processes may result in visual artifacts and rendering latency. For instance, when a user operates the user interface of the smart television while the smart television is rendering a graphical output of process 104 and/or process 112, rendering of the user interface may be delayed. In addition, when the user interacts with the user interface, the response to the interaction may be delayed as well preventing the efficient utilization of the smart television.

The systems and methods described herein include a consolidated compositing block architecture configured to write directly to the framebuffer at/dev/fb0, which may correspond the first framebuffer device in the operating system of a display device (e.g., such as a Linux-based operation system, etc.). A framebuffer may be an intermediate stage between the graphics hardware and the final output on the display (e.g., a television, monitor, etc.). The framebuffer may correspond to a region of random-access memory (or other memory that contains a bitmap that drives a display. The bitmap may represent each pixel of the display. The region of RAM may be written to or read from (like any other accessible memory). The operating system may reference devices as files, which may enable access to the framebuffer through a special file located in the /dev directory. The name “fb0” may refer the first (or primary) framebuffer device available on the system. Multiple framebuffer devices can be provided with the framebuffers being sequentially numbered (e.g., /dev/fb1, /dev/fb2). Software processes can access and manipulate the framebuffer directly by reading and writing pixel data to/dev/fb0. This approach provides a low-level method for managing graphics output without the need for more complex graphical libraries, such as OpenGL.

The/dev directory may store operating system libraries of software interfaces including framebufers (e.g., fb0, fb1, etc.), audio libraries (e.g., drivers, etc.), network libraries (e.g., Ethernet drivers, etc.), hardware libraries (e.g., universal serial bus drivers, etc.), etc.

In some examples, the consolidated compositing block architecture may write directly to /dev/fb0 without passing through a Direct Framebuffer (DirectFB). DirectFB is a software library that provides graphics acceleration, input device handling and abstraction layer, and integrated windowing system with support for translucent windows and multiple display layers on top of the Linux framebuffer without requiring any kernel modifications.

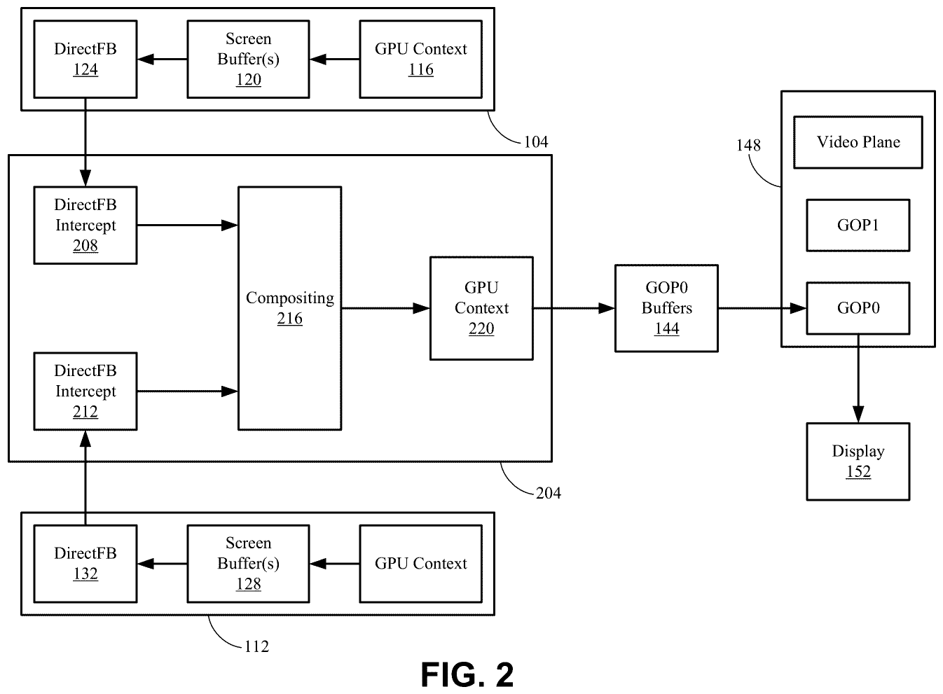

FIG. 2 illustrates a block diagram of an example graphics management subsystem including a consolidated compositing block architecture according to aspects of the present disclosure. Consolidated compositing block 204 is configured to intercept calls executed by DirectFB processes and consolidate the graphical data into a single compositing process. The single graphical output may then be output to HAL 148 via temporary memory buffer 144. Since there is single call to HAL 148 for the one or more processes providing graphical output, fewer temporary memory buffers may be instantiated substantially decreasing the load on the processing hardware and latency when providing graphical output, which may increase responsiveness of graphical applications executing on the display device such as user interfaces or the like.

Consolidated compositing block 204 may include DirectFB intercept process 208, and DirectFB intercept process 212. In some instances, consolidated compositing block 204 may include any number of DirectFB intercept processes. In some instances, a single DirectFB intercept process may be configured to intercept calls from any number of DirectFB processes. DirectFB intercept process 208 and DirectFB intercept process 212 may be configured to intercept calls from DirectFB process and the GPU render process.

In some instances, the DirectFB library may be modified to call DirectFB intercept processes. In other instances, the DirectFB library may not be modified. In those instances, consolidated compositing block 204 may catch the call before the call causes a GOP buffer to be instantiated.

Consolidated compositing block 204 may include GPU context 220 configured to internalize the system-level processes (e.g., user interfaces associated with the operating system, native processes of the display device, etc.) and/or graphical output of first-party applications or processes (e.g., application and/or process native to the display device or designated as being native to the display device via user input or the like). As a result, the processes providing system-level graphical output and/or first party applications or processes may not execute as external processes (e.g., such as processes 104, 108, 112, etc.). Consolidated compositing block 204 may perform compositing with the same context used to render the system-level graphical output and/or first-party application or processes without providing additional contexts. By internalizing the system-level processes and/or first-party application or processes into consolidated compositing block 204, the graphical output of the system-level processes or first-party application or processes can be facilitated (and/or prioritized) even when other processes are requesting compositing, which may optimize resource utilization for rendering graphical output and reduce the latency of updating the system-level processes or first-party application or processes (e.g., such as when a user interacts with the system-level user interface, etc.).

Consolidated compositing block 204 may generate a single context (e.g., compositing 216) to process the calls to the GPU render process intercepted from the multiple DirectFB processes. Compositing 216 may process the graphical data included in the intercepted calls by compositing the many layers of graphical data into single graphics plane 220. For example, single graphics plane 220 may be defined from the graphical data intercepted from the DirectFB processes and based on a determination of what is to be rendered, an identification of the layers of each portion of graphical data, an identification of portions of the graphical data that may be occluded (e.g., such as a portion of a window that may not be visible when another window is rendered on top of it), etc. Consolidated compositing block 204 may execute a call to HAL to render single graphics plane 220. single graphics plane 220 may be passed to Graphics Output Protocol (GOP) buffer (e.g., temporary memory buffer 144) to continue onward through the aforementioned graphics pipeline.

In some examples, such as when consolidated compositing block 204 is implemented within a Linux-based operating system, a framebuffer (fb) may be utilized in addition or in place of DirectFB. A framebuffer may correspond to a region of random-access memory (or other memory that contains a bitmap that drives a display. The bitmap may represent each pixel of the display. The region of RAM may be written to or read from (like any other accessible memory). The operating system may expose the region of RAM with a reference/dev/fb0. Dev corresponds to a location of special device files and fb0 represents framebuffer 0. /dev/fb0 may be configured before instantiating consolidated compositing block 204. Configuring/dev/fb0 may include selecting between 4 k and 1080p at startup, configuring the framebuffer to use ARM Framebuffer Compression (AFBC), optionally implementing parallelism by coordinating with/dev/fb0 separately from a GPU thread. Implementing consolidated compositing block 204 may include implementing double buffering, a triple buffering, or n-buffering.

In some examples, consolidated compositing block 204 may operate by writing directly to /dev/fb0 where a unified compositing process may render the written graphical data without utilizing a DirectFB process. In this example, /dev/fb0 may be configured by an initialization process when the display device is power on or when an operating system of the display device is booted. In other examples, the display device may include a system on a chip (SOC) that may include a modification or configuration of DirectFB.

In either example, the consolidated compositing block 204 may be configured prior to compositing graphical data. The configuration may include selecting a display resolution at startup, determining whether to configuring framebuffer to use AFBC, determining whether to activate parallel processing (e.g., causing the consolidated compositing block 204 to wait on (to synchronize with) /dev/fb0 separately from the thread that waits on the GPU), and/or the like. Activating parallel processing may be implemented by controlling /dev/fb0 directly or by using one or more application programming interfaces (APIs) for DirectFB.

Visual artifacts (e.g., screen tearing, etc.) can occur when processing buffer data during screen refreshes. The consolidated compositing block 204 may prevent visual artifacts by processing the buffer data between screen refreshes. For example, consolidated compositing block 204 may transmit a vertical-sync (VSync) signal that synchronizes the processing of the buffer data with the screen refresh (or the time between screen refreshes). The graphics process may sleep (e.g., wait) until the VSync signal is received to process one or more buffers instantiated since the previous processing of buffer data. If a new buffer is detected, a reference to the previous buffer may be deleted and the processing proceeds with using the new buffer. The graphics process may then execute a call to the HAL interface to composite the buffers.

Windows can be imported into the consolidated compositing block architecture by using the buffers of other applications as GPU textures. GPU textures, in the context of Linux app development, may be specialized data structures used to store and represent image data on the GPU. Textures may provide the visual details that make up the appearance of 3D objects and scenes in a graphical application. Textures may represent various graphical properties such as color, transparency, reflections, etc.

A texture may be a two-dimensional (2D) array of pixels, where each pixel contains specific information such as color, transparency, or other attributes. Textures can come in various formats, like 1D, 2D, 3D, cubemaps (which represent six 2D textures organized in a cube-like structure), etc. Each of these formats may provide a different purpose and is used in different scenarios. For GPU rendering, textures may be managed through the OpenGL ES API. These APIs provide a set of functions and commands to create, manipulate, and render textures. In some instances, the managing textures may involves: 1. Loading the texture data (e.g., from an image file) into memory, 2) Creating a texture object on the GPU and binding it, 3) Specifying the texture parameters such as filtering, wrapping mode, and mipmapping, 4) Uploading the texture data to the GPU, which stores it in its dedicated memory, 5) Binding the texture to a specific texture unit during rendering, and 6) Using a shader program to sample the texture and apply it to the 3D objects in the scene.

Binding a texture may refer to the association of the texture object with a specific texture unit, effectively making it the active texture for subsequent operations. The process of binding a texture may establish a connection between the texture object and the GPU's texture processing pipeline, allowing the GPU to access and manipulate the texture data. Binding a texture may identify the texture object that is to be used for any subsequent texture-related operations, such as setting texture parameters, rendering with a shader program, etc. InOpenGL ES, for example, textures can be bound using glBindTexture: glBindTexture(GL_TEXTURE_2D, textureId), where GL_TEXTURE_2D represents the texture target (2D textures in this example), and textureId may refer to the unique identifier for the texture object created earlier with glGenTextures.

Once a texture is bound to a texture unit, various operations may be executed on the texture, such as setting its filtering and wrapping modes, uploading the texture data, specifying the mipmapping level, etc. When rendering, the shader program can access the active texture by sampling active texture using texture coordinates, which may enable the texture to be applied to 3D objects in the scene. Binding a texture is a stateful operation, which means that the binding will remain active until you explicitly change it by binding another texture or unbinding the current texture. To unbind a texture, you can call glBindTexture with a texture identifier of 0: glBindTexture(GL_TEXTURE_2D, 0).

A texture unit may be a component within the GPU that handles texture processing and mapping during rendering. The texture unit may manage and applying textures to 3D geometry in a scene, etc. GPUs may include multiple texture units, which may enable processing multiple textures in parallel (e.g., approximately simultaneously), enabling more complex rendering effects. Texture units may be part of the GPU's rendering pipeline. When rendering a scene, the GPU processes each fragment (or pixel) of the geometry and determines which textures should be applied to it. The texture units can fetch the texture data, perform filtering, and combine the textures with the fragment's color data to produce the final output.

In OpenGL ES, for example, different textures can be bound to different texture units by first activating a texture unit using glActiveTexture, followed by binding the texture: glActiveTexture(GL_TEXTURE0+textureUnitIndex); glBindTexture(GL_TEXTURE_2D, textureId); where, GL_TEXTURE0 represents the first texture unit, and textureUnitIndex represents an integer value used to select the specific texture unit to activate (e.g., 0 for the first unit, 1 for the second unit, and so on). After activating the texture unit, a texture can be bound to the texture unit using the glBindTexture, as previously described. In implementations including shader programs, textures bound to different texture units can be accessed by declaring uniform sampler variables in the shader code. The uniform sampler variables may be used to fetch the texture data based on texture coordinates. For example, in a fragment shader, you might declare a sampler like this: uniform sampler2D myTexture. The uniform value can be to match the texture unit index you used when binding the texture: GLint myTextureLocation=glGetUniformLocation(shaderProgramId, “myTexture”); glUniform1i(myTextureLocation, textureUnitIndex).

The consolidated compositing block architecture may use the buffers of other applications as GPU textures by acquiring the buffer, creating a texture object, copying the buffer data, and using the texture in rendering. Buffers may be acquired based on permissions of the consolidated compositing block architecture. Consolidated compositing block architecture may obtain permissions to access buffers directly from an application or process associated with the buffer (e.g., the application or process outputting graphics) or the consolidated compositing block architecture may obtain system-level permissions. Once the buffer is acquired, the application may generate a texture object that may store image data by, for example, allocating memory of the GPU, defining the format of the texture, setting other properties such as the filtering mode, and/or the like. The application may then copy the data from the acquired buffer into the texture object. In some instances, the application may access specialized APIs such as glTexSubImage2D or glCopyTexSubImage2D to transfer the data from the buffer to the texture. Once the data has been copied to the texture, the texture can be used as a standard texture in rendering. For example, the rendering can include binding the texture to a texture unit, setting its sampling parameters, using it in vertex and fragment shaders to render a scene, and/or the like.

The process of using the buffers of other applications as GPU textures may vary depending on the platform and APIs being used. For example, applications can use the SurfaceTexture class to acquire buffers from other applications and use them as textures. Similarly, the DirectX® API may provide mechanisms for sharing textures between applications. Regardless of platform or API, individual applications may not attempt to composite the buffers themselves after rendering a frame, the consolidated compositing block architecture may be notified when a buffer is updated, and the consolidated compositing block architecture may be configured to lock/unlock and read window buffers.

The following example API may be implemented by the SoC of the display device:

| | |
|---|---|
| 1 | struct Window { |
| 2 | // PID of the process owning this window |
| 3 | pid_t pid; |
| 4 | |
| 5 | // EGLImage handles to the buffers |
| 6 | EGLImage buffers[3]; |
| 7 | |
| 8 | // Index into ‘buffers' that should currently be displayed |
| 9 | int current_buffer; |
| 10 | |
| 11 | // Width and height of the buffers in pixels |
| 12 | int buffers_width, buffers_height; |
| 13 | |
| 14 | // Source rectangle that should be read from the buffer |
| 15 | int src_left, src_top, src_width, src_height; |
| 16 | |
| 17 | // Destination rectangle that the buffer should be written to |
| 18 | int dst_left, dst_top, dst_width, dst_height; |
| 19 | |
| 20 | // Opacity of the window from 0 - 255 |
| 21 | uint8_t opacity; |
| 22 | |
| 23 | // DirectFB layer of the window |
| 24 | int layer; |
| 25 | }; |
| 26 | |
| 27 | // Register a callback that is called whenever a window has a new |

buffer that needs to be composited, or the opacity of a window has changed

| | |
|---|---|
| 29 | void set_window_change_callback(void(*window_change_callback)( )); |
| 30 | |
| 31 | // Return a list of windows that need to be composited, locking their |
| 32 | // current buffers from being modified. |
| 33 | void lock_windows(int max_windows, struct Window * windows, int * |

window_count);

| | |
|---|---|
| 34 | |
| 35 | // Allow the previously locked windows to be modified again. |
| 36 | void unlock_windows( ); |

The example API may be tailored to operate using DirectFB. In some implementations, consolidated compositing block architecture can provide services as a Wayland server. Wayland is a display protocol configured to be more efficient and flexible than older protocols such as X windowing system (X11). By acting as a Wayland server, the consolidated compositing block architecture may be configured to provide improved graphics performance, more efficient resource usage, and greater flexibility and compatibility with other software components.

While the consolidated compositing block architecture may include access to windows on Layer 0 for compositing, the consolidated compositing block architecture may include access to both Layer 1 and Layer 0 in the API for additional features such as, but not limited, the ability to create transition animations that use the GPU to composite Layer 1 applications temporarily, produce screenshots that combine both Layer 1 and Layer 0 for test automation, inspect Layer 1 windows for GPU-based blank screen detection, and/or the like. By including both layers in the API, the disclosed system can provide a more comprehensive solution for graphics rendering that addresses a wider range of use cases and scenarios.

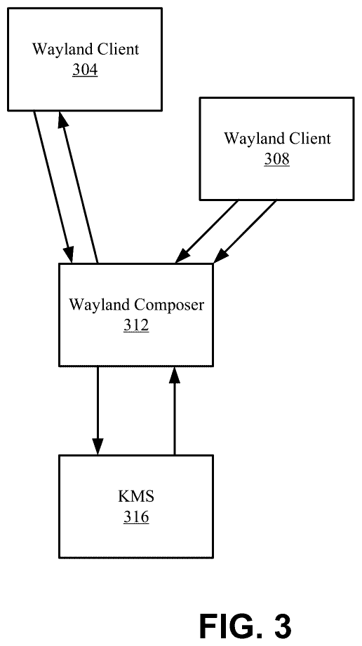

In some examples, the consolidated compositing block architecture can be implemented without using the DirectFB library. For example, FIG. 3 illustrates a block diagram of an example graphics compositing system utilizing a Wayland compositor in place of the DirectFB according to aspects of the present disclosure. The Wayland compositor operates similar to the DirectFB process. Wayland client 304 and Wayland client 308 represent applications or process executing within the operating system that may render graphics. Each Wayland client may instantiate a shared buffer that can be accessed by the Wayland client and Wayland compositor 312. When a Wayland client generates a new graphical output from a Wayland client, the Wayland client may instantiate the shared buffer and call Wayland compositor 312. Wayland compositor 312 may then facilitate presentation of the graphical output via kernel or self-contained libraries (KMS 316).

KMS 316 may transmit events to Wayland compositor 316 such as when user input is received that may cause a modification to the graphical output of a Wayland client (e.g., such as selection of a window from one or more windows being displayed, selection of an object or button or the like, execution of a new application, etc.). Wayland compositor 316 may then execute a call to a Wayland client that may be impacted by the event to cause the Wayland client to update the graphical output. The Wayland client may generate a modified graphical output based on the event and instantiate a new buffer. The Wayland client may then execute a call to Wayland compositor 316 identifying the new buffer to cause Wayland compositor 316 to access the new buffer and facilitate presentation of the modified graphical output. Alternatively, the Wayland client may reuse the previously instantiated buffer. Reusing the previously instantiate buffer may cause a race condition based on the previous contents of the buffer and the new contents of the buffer if Wayland compositor 316 is still processing portions of the old contents of the buffer.

The consolidated compositing block architecture may be implemented within Wayland compositor 316 to optimize resource utilization and latency when rendering graphics. For instance, the consolidated compositing block architecture may internalize graphical process for some graphical processes (e.g., such as system-level processes, first-party applications or processes, other processes native to the operating system, etc.). The graphical processes may not execute as Wayland clients, but instead as subprocesses of Wayland compositor 316 (e.g., as described above in connection to GPU context 220 of the consolidated compositing block) eliminating the need to execute some Wayland clients and eliminating the memory and processing resources that would be dedicated to those Wayland clients and the interaction between those Wayland clients and Wayland compositor 316. In addition, since the graphical processes are internalized within Wayland compositor 316, processing of graphical data of the graphical processes may be quicker, and in some instances, prioritized over the graphical data Wayland clients.

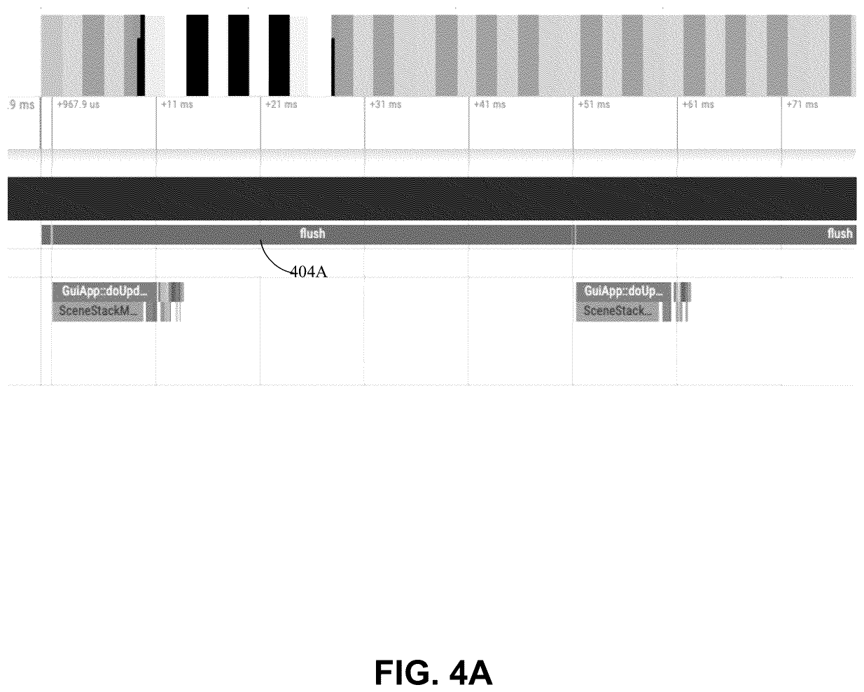

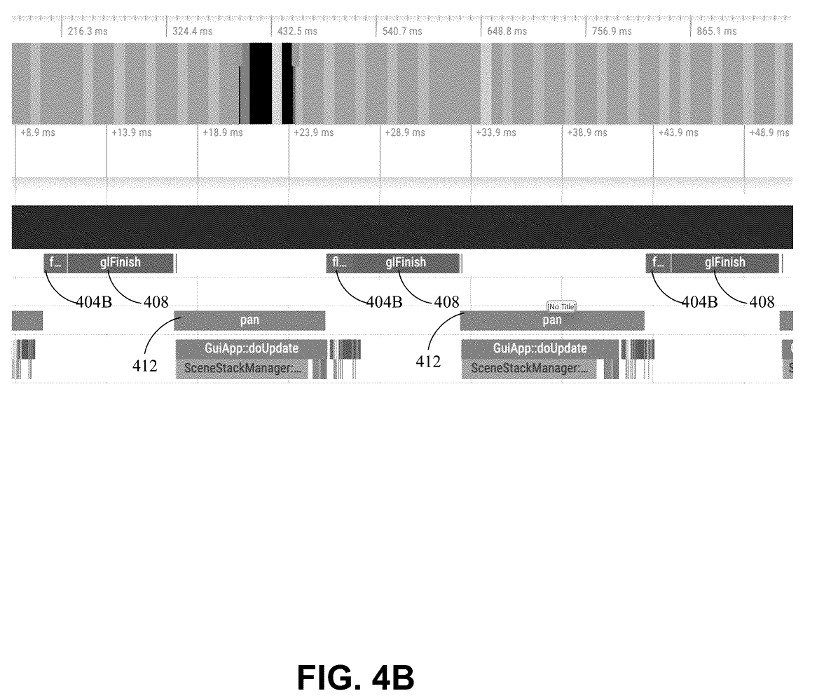

FIG. 4A and FIG. 4B provide example graphic representation of the optimizations implemented by the consolidated compositing block architecture, shown in FIG. 4B, compared to the current architecture, shown in FIG. 4A. The time allocation trace can be generated when a display device is rendering a SmartCast Home (e.g., an example GPU intensive user interface used to provide a benchmark of the consolidated compositing block architecture) and configured to operate at 60 frames per second. Flush 404 represents the time spent issuing commands to the GPU, glFinish indicates the time spent waiting on the GPU to render, and pan 412 is the time spent waiting on VSynch after the GPU finished rendering. GuiApp::doUpdate, and SceneStackManager are processes being rendered by the current compositing architecture and the example graphic depicts the time allocation of each process including the processes of the GPU.

FIG. 4A illustrates an example graph representation of a time allocation trace generated using current architecture according to aspects of the present disclosure. The current compositing architecture was configured to render directly to GOP0 display controller without utilizing the DirectFB compositor. As shown by the example graph, flush 404A takes 50 milliseconds as the GPU is blocked waiting on the compositor to finish compositing the previous frame (e.g. processing the buffers instantiated each time GuiApp::doUpdate, and SceneStackManager generates graphical data). The time interval of flush 404 may limit the framerate of the display device to 20 frames pers second instead of the 60 frames per second the display device is configured to present.

FIG. 4B illustrates an example graph representation of a time allocation trace generated using consolidated compositing block architecture according to aspects of the present disclosure. The consolidated compositing block architecture removes the bottleneck caused when compositing by providing a single consolidated compositing block. As shown in FIG. 4B, flush 404B is reduced to below to below 2 milliseconds. As a result, the latency of updating the user interface (in this example) is significantly reduced, which may increase the frame rate to the configured frame rate (e.g., 60 frames per second), and increase the responsiveness of the user interface to user interaction.

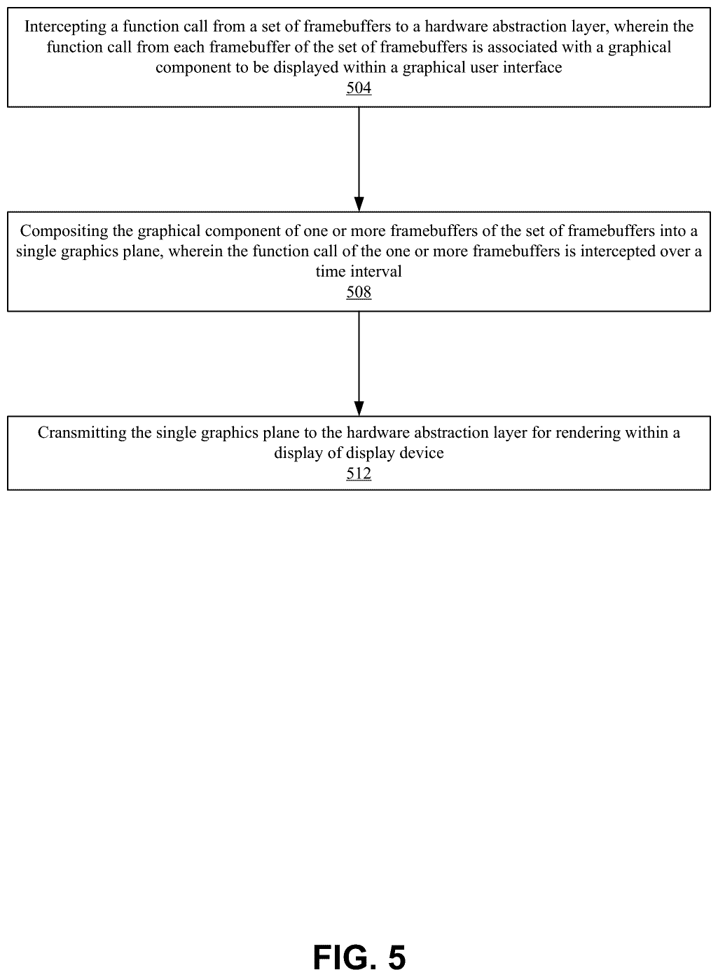

FIG. 5 illustrates a flowchart of an example process for detecting boundaries relative to linear programming according to aspects of the present disclosure. At block 504, a graphics subsystem (e.g., such as the consolidated compositing block architecture as described in connection to FIG. 2) of a display device (e.g., monitor, television, etc.) that may intercept a function call from a set of framebuffers to a hardware abstraction layer (HAL). HAL is a software layer positioned between the operating system and the computer hardware providing an interface for the operating system to interact with different hardware components including graphics hardware. The function call from each framebuffer of the set of framebuffers may be associated with a graphical component to be displayed on a display. For example, the graphical component may correspond to a window, a user interface element, a user interface or any portion thereof, an image, and/or the like. The graphical component may be a new graphical component (e.g., a graphical component that has not yet been displayed) or a modified version of a currently displayed graphical component (e.g., such as a modified user interface element to be displayed after receiving user input, etc.).

The framebuffer may be a component or process of an application or process executing on the display device. In some examples, the framebuffer may be a native buffer of the operating system accessed via/dev/fb0 where fb0 denotes a first or primary framebuffer and can be replaced with another identifier associated with another framebuffer in the dev directory. In those instances, the function call may be to write or read from the framebuffer at/dev/fb0 to render the contents of the framebuffer. In other examples, the framebuffer may be a direct frame buffer (DirectFB) process configured to pass graphical data to the graphics processing pipeline of the HAL. In still yet other instances, the framebuffer may be a buffer of a Wayland client configured to call a Wayland compositor to render the graphical component. In those instances, the graphics subsystem may intercept the function call to the Wayland compositor (rather than the HAL).

The graphics subsystem may intercept the function call by monitoring the framebuffers, trapping the function call, and redirecting the function call to the graphics subsystem. Alternatively, the framebuffer may be modified to direct the function call to the graphics subsystem. For instance, the framebuffer may be a DirectFB process instantiated from the DirectFB library. The DirectFB library may be modified to cause the DirectFB processes to call the graphics subsystem in place of the HAL.

At block 508, the graphics subsystem may perform compositing using the graphical component of one or more framebuffers of the set of framebuffers into a single graphics plane. The compositor may be configured to generate a single graphics plane (e.g., a scene to displayed within the display of the display device) based on the graphical data received in one or more intercepted function calls. In some examples, the compositor may retain graphical data received from the intercepted function calls, which may be usable to maintain the graphic displayed when an intercepted function call includes graphical data impacting a portion of the graphic, a window displayed within the graphic, etc. For example, when a window of a user interface is updated, the compositor may receive new graphical component that corresponds to the updated portion of the window (or a new version of the entre window) and composite a new graphics plane that includes the new graphical component (or modify the previously rendered graphics plane to incorporate the new graphical component). In some instances, the compositor may be configured to generate a single graphics plane from two or more intercepted function calls received within a time interval of each other.

In some instances, the graphics subsystem may include one or more subprocesses configured to internalize the system-level processes (e.g., user interfaces associated with the operating system, native processes of the display device, etc.) and/or graphical output of first-party applications or processes (e.g., application and/or process native to the display device or designated as being native to the display device via user input or the like). In those instances, the processes providing system-level graphical output and/or first-party applications or processes may not execute as external processes. The graphics subsystem may perform compositing with the same context used to render the system-level graphical output and/or first-party application or processes without providing additional contexts. By internalizing the system-level processes and/or first-party application or processes into the graphics subsystem, the graphical output of the system-level processes or first-party application or processes can be facilitated (and/or prioritized) even when other processes are requesting compositing, which may optimize resource utilization for rendering graphical output and reduce the latency of updating the system-level processes or first-party application or processes (e.g., such as when a user interacts with the system-level user interface, etc.).

At block 512, the graphics subsystem may transmit the single graphics plane to the hardware abstraction layer for rendering via the graphics processing pipeline of the display device. By intercepting the function calls from the framebuffers the graphics subsystem may prevent the instantiation of additional buffers (e.g., one or more for each call by a framebuffer), which may reduce the consumption of the processing resources of the display device, increase the rate in which the graphics processing pipeline can present graphical content, and decrease the latency when interacting with graphical elements being displayed (e.g., such as user interface elements, etc.).

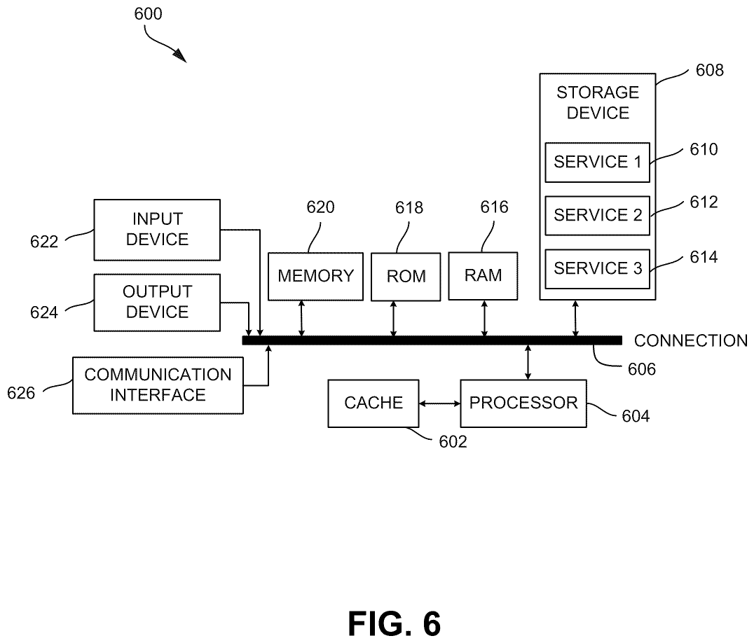

FIG. 6 illustrates an example computing device according to aspects of the present disclosure. For example, computing device 600 can implement any of the systems or methods described herein. In some instances, computing device 600 may be a component of or included within a media device. The components of computing device 600 are shown in electrical communication with each other using connection 606, such as a bus. The example computing device architecture 600 includes a processor (e.g., CPU, processor, or the like) 604 and connection 606 (e.g., such as a bus, or the like) that is configured to couple components of computing device 600 such as, but not limited to, memory 620, read only memory (ROM) 618, random access memory (RAM) 616, and/or storage device 608, to processing unit 610.

Computing device 600 can include a cache 602 of high-speed memory connected directly with, in close proximity to, or integrated within processor 604. Computing device 600 can copy data from memory 620 and/or storage device 608 to cache 602 for quicker access by processor 604. In this way, cache 602 may provide a performance boost that avoids delays while processor 604 waits for data. Alternatively, processor 604 may access data directly from memory 620, ROM 617, RAM 616, and/or storage device 608. Memory 620 can include multiple types of homogenous or heterogeneous memory (e.g., such as, but not limited to, magnetic, optical, solid-state, etc.).

Storage device 608 may include one or more non-transitory computer-readable media such as volatile and/or non-volatile memories. A non-transitory computer-readable medium can store instructions and/or data accessible by computing device 600. Non-transitory computer-readable media can include, but is not limited to magnetic cassettes, hard-disk drives (HDD), flash memory, solid state memory devices, digital versatile disks, cartridges, compact discs, random access memories (RAMs) 625, read only memory (ROM) 620, combinations thereof, or the like.

Storage device 608, may store one or more services, such as service 1 610, service 2 612, and service 3 614, that are executable by processor 604 and/or other electronic hardware. The one or more services include instructions executable by processor 604 to: perform operations such as any of the techniques, steps, processes, blocks, and/or operations described herein; control the operations of a device in communication with computing device 600; control the operations of processing unit 610 and/or any special-purpose processors; combinations therefor; or the like. Processor 604 may be a system on a chip (SOC) that includes one or more cores or processors, a bus, memories, clock, memory controller, cache, other processor components, and/or the like. A multi-core processor may be symmetric or asymmetric.

Computing device 600 may include one or more input devices 622 that may represent any number of input mechanisms, such as a microphone, a touch-sensitive screen for graphical input, keyboard, mouse, motion input, speech, media devices, sensors, combinations thereof, or the like. Computing device 600 may include one or more output devices 624 that output data to a user. Such output devices 624 may include, but are not limited to, a media device, projector, television, speakers, combinations thereof, or the like. In some instances, multimodal computing devices can enable a user to provide multiple types of input to communicate with computing device 600. Communications interface 626 may be configured to manage user input and computing device output. Communications interface 626 may also be configured to managing communications with remote devices (e.g., establishing connection, receiving/transmitting communications, etc.) over one or more communication protocols and/or over one or more communication media (e.g., wired, wireless, etc.).

Computing device 600 is not limited to the components as shown if FIG. 6. Computing device 600 may include other components not shown and/or components shown may be omitted.

The following examples illustrate various aspects of the present disclosure. As used below, any reference to a series of examples is to be understood as a reference to each of those examples disjunctively (e.g., “Examples 1-4” is to be understood as “Examples 1, 2, 3, or 4”).

Example 1 is a method comprising: intercepting a function call from a set of framebuffers to a hardware abstraction layer, wherein the function call from each framebuffer of the set of framebuffers is associated with a graphical component to be displayed within a graphical user interface; compositing the graphical component of one or more framebuffers of the set of framebuffers into a single graphics plane, wherein the function call of the one or more framebuffers is intercepted over a time interval; and transmitting the single graphics plane to the hardware abstraction layer for rendering within a display of display device.

Example 2 is the method of any of example(s) 1 and 3-7, wherein at least one framebuffer of the set of framebuffers is a Direct Framebuffer.

Example 3 is the method of any of example(s) 1-2 and 4-7, wherein the single graphics plane is transmitted to graphics output protocol buffer of the hardware extraction layer.

Example 4 is the method of any of example(s) 1-3 and 5-7, wherein the framebuffer is configured to use Arm Framebuffer Compression.

Example 5 is the method of any of example(s) 1-4 and 6-7, where intercepting a function call from a set of framebuffers includes de-registering the function call to the hardware abstraction layer and redirecting the function call to a consolidated compositing block.

Example 6 is the method of any of example(s) 1-5 and 7, wherein each framebuffer is associated with a different process executing on the display device and configured to output a graphical component.

Example 7 is the method of any of example(s) 1-6, wherein the function call from a set of framebuffers is intercepted after a windowing process and before graphics rendering.

Example 8 is a system comprising: one or more processors; a non-transitory computer-readable medium storing instructions that when executed by the one or more processors, cause the one or more processors to perform any of methods 1-7.

Example 9 is a non-transitory computer-readable medium storing instructions that when executed by one or more processors, cause the one or more processors to perform any of methods 1-7.

Client devices, user devices, computing devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a keypad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 902) include, but is not limited to, desktop computers, laptop computers, server computers, hand-held computers, tablets, smart phones, personal digital representatives, digital home representatives, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the example process 800 of FIG. 8). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some examples, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital representative (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 902.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 45 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term.

Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

1. A method comprising:
intercepting a function call from a set of framebuffers to a hardware abstraction layer, wherein the function call from each framebuffer of the set of framebuffers is associated with a graphical component to be displayed within a graphical user interface;
compositing the graphical component of one or more framebuffers of the set of framebuffers into a single graphics plane, wherein the function call of the one or more framebuffers is intercepted over a time interval; and
transmitting the single graphics plane to the hardware abstraction layer for rendering within a display of display device.

2. The method of claim 1, wherein at least one framebuffer of the set of framebuffers is a Direct Framebuffer.

3. The method of claim 1, wherein the single graphics plane is transmitted to a graphics output protocol buffer of the hardware abstraction layer.

4. The method of claim 1, wherein the one or more framebuffers are configured to use Arm Framebuffer Compression.

5. The method of claim 1, wherein intercepting the function call from the set of framebuffers includes de-registering the function call to the hardware abstraction layer and redirecting the function call to a consolidated compositing block.

6. The method of claim 1, wherein each framebuffer is associated with a different process executing on the display device and configured to output a graphical component.

7. The method of claim 1, wherein the function call from a set of framebuffers is intercepted after a windowing process and before graphics rendering.

8. A system comprising:
one or more processors;
a non-transitory computer-readable medium storing instructions that when executed by the one or more processors, cause the one or more processors to perform operations including:
intercepting a function call from a set of framebuffers to a hardware abstraction layer, wherein the function call from each framebuffer of the set of framebuffers is associated with a graphical component to be displayed within a graphical user interface;
compositing the graphical component of one or more framebuffers of the set of framebuffers into a single graphics plane, wherein the function call of the one or more framebuffers is intercepted over a time interval; and
transmitting the single graphics plane to the hardware abstraction layer for rendering within a display of display device.

9. The system of claim 8, wherein at least one framebuffer of the set of framebuffers is a Direct Framebuffer.

10. The system of claim 8, wherein the single graphics plane is transmitted to a graphics output protocol buffer of the hardware abstraction layer.

11. The system of claim 8, wherein the one or more framebuffers are configured to use Arm Framebuffer Compression.

12. The system of claim 8, wherein intercepting the function call from the set of framebuffers includes de-registering the function call to the hardware abstraction layer and redirecting the function call to a consolidated compositing block.

13. The system of claim 8, wherein each framebuffer is associated with a different process executing on the display device and configured to output a graphical component.

14. The system of claim 8, wherein the function call from a set of framebuffers is intercepted after a windowing process and before graphics rendering.

15. A non-transitory computer-readable medium storing instructions that when executed by one or more processors, cause the one or more processors to perform operations including:
intercepting a function call from a set of framebuffers to a hardware abstraction layer, wherein the function call from each framebuffer of the set of framebuffers is associated with a graphical component to be displayed within a graphical user interface;
compositing the graphical component of one or more framebuffers of the set of framebuffers into a single graphics plane, wherein the function call of the one or more framebuffers is intercepted over a time interval; and
transmitting the single graphics plane to the hardware abstraction layer for rendering within a display of display device.

16. The non-transitory computer-readable medium of claim 15, wherein at least one framebuffer of the set of framebuffers is a Direct Framebuffer.

17. The non-transitory computer-readable medium of claim 15, wherein the single graphics plane is transmitted to a graphics output protocol buffer of the hardware abstraction layer.

18. The non-transitory computer-readable medium of claim 15, wherein the one or more framebuffers are configured to use Arm Framebuffer Compression.

19. The non-transitory computer-readable medium of claim 15, wherein intercepting the function call from the set of framebuffers includes de-registering the function call to the hardware abstraction layer and redirecting the function call to a consolidated compositing block.

20. The non-transitory computer-readable medium of claim 15, wherein each framebuffer is associated with a different process executing on the display device and configured to output a graphical component.
